(19) United States
(12) Patent Application Publication
(10) Pub. No.: US 2017/0216754 A1
(43) Pub. Date: Aug. 3, 2017

(54) ILLUMINATION DEVICE FOR AIR CLEANER ASSEMBLY

(71) Applicants: Seth G. Ingham, Amery, WI (US); Kyle W. Enloe, Stillwater, MN (US)

(72) Inventors: Seth G. Ingham, Amery, WI (US); Kyle W. Enloe, Stillwater, MN (US)

(21) Appl. No.: 15/010,924

(22) Filed: Jan. 29, 2016

(51) Int. Cl. B01D 46/42; B60Q 1/00; B60Q 3/06

(52) U.S. Cl. CPC B01D 46/4254; B60Q 3/06; B60Q 1/0005; B60Q 1/0088; B01D 2265/028; B01D 2279/60; F02M 35/0201

(57) ABSTRACT

An illumination device for an air cleaner assembly includes a housing and a number of light sources attached to the housing for emitting light to produce a glowing appearance.

### TECHNICAL FIELD

The present disclosure relates generally to air cleaner assemblies, and more particularly to air cleaner assemblies for vehicles.

### BACKGROUND

Vehicle air cleaner assemblies often use air filter mediums to filter out contaminants, such as dirt, from the air entering the intake of the engine. An air filter may be positioned on the outside of an opening of the intake to surround the opening, preventing unwanted ingress of contaminants. Air is directed through the air filter while contaminants are collected on the filter medium.

### SUMMARY

The present application discloses one or more of the features recited in the appended claims and/or the following features which, alone or in any combination, may comprise patentable subject matter:

According to one aspect of the present disclosure, an air cleaner illumination device for an intake of a motorized vehicle is disclosed, the illumination device may include a housing, a number of light sources attached to the housing and sealed to prevent contact with fluids, and a wiring harness electrically connected to the number of light sources. A passageway may be defined in the housing and may be sized to permit flow of air into the intake of the motorized vehicle. The number light sources may be arranged around the passageway.

In some embodiments, the passageway may extend through the housing along a first axis between a first opening defined in the housing and a second opening defined in the housing.

In some embodiments, the passageway may be defined by a curved inner surface of the housing that extends between the first opening and the second opening when viewed in a cross-section taken along the first axis.

In some embodiments, the passageway may be defined by a horn-shaped annular surface of the housing that extends between the first opening and the second opening.

In some embodiments, the housing may include a number of cantilevered fingers extending therefrom, and each finger may be configured to be received in an opening defined in the motorized vehicle.

In some embodiments, each of the number of fingers may include a flange extending from a rear wall of the housing to an end of the flange that is spaced apart from the rear wall.

In some embodiments, each of the number of fingers may include a tab extending from the end of the flange in a radially outward direction.

In some embodiments, the air cleaner illumination device may include a controller configured to operate the number of light sources for a least one of flashing and changing color.

In some embodiments, the number of light sources may include a plurality of light emitting diodes.

According to another aspect of the present disclosure, an air cleaner assembly for an intake of a motorized vehicle may include an intake mounting plate including an intake receptacle, an air filter positioned on the intake mounting plate, and an air cleaner illumination device including a housing and a number of light sources for emitting light disposed at least partly within the housing. The air cleaner illumination device may be positioned such that the number of light sources emit light through the air filter.

In some embodiments, the number of light sources may be sealed by the housing to prevent contact with fluids.

In some embodiments, the housing may include a passageway defined therein, and the passageway may be sized to permit flow of air into the intake of the motorized vehicle and extending through the housing along a first axis between a first opening defined by the housing and a second opening defined by the housing.

In some embodiments, the number light sources may include a plurality of light sources arranged around the passageway.

In some embodiments, the passageway may be defined by a curved annular surface of the housing that extends between the first opening and the second opening when viewed in a cross-section taken along the first axis.

In some embodiments, the passageway may be defined by a horn-shaped annular surface of the housing that extends between the first opening and the second opening.

In some embodiments, the housing may include a number of cantilevered fingers extending from the housing. Each finger may be configured for engagement with the intake receptacle of the mounting plate.

In some embodiments, each of the number of fingers may include a flange extending from a wall of the housing to an end of the flange that is spaced apart from the wall.

In some embodiments, each of the number of fingers may include a tab extending from the end of the flange in a radially outward direction for snap-fitting engagement with the intake receptacle of the mounting plate.

According to another aspect of the present disclosure, an air cleaner assembly for an intake of a motorized vehicle may include a filter housing including a backplate defining an intake receptacle and a cover configured to attach to the backplate, the filter housing defining a filter chamber, a filter shaped to define an interior cavity, the filter being sized to be received within the filter chamber, and an air cleaner illumination device including an illumination housing and a number of light sources for emitting light attached to the illumination housing. The air cleaner illumination device may be engaged within the intake receptacle and positioned within the interior cavity of the filter such that the number of light sources emit light from within the filter.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the following figures, in which:

FIG. 1 is a perspective view of an air cleaner assembly;

FIG. 2 is an exploded perspective view of the air cleaner assembly of FIG. 1;

FIG. 3 is a perspective view of an air cleaner illumination device of the assembly of FIGS. 1 and 2;

FIG. 4 is a front plan view of the air cleaner illumination device of FIG. 3;

FIG. 5 is a side elevation cross-sectional view of the air cleaner illumination device of the assembly of FIGS. 3 and 4 taken along the line 5-5 of FIG. 4;

FIG. 6 is a rear perspective view the air cleaner illumination device of FIGS. 3-5, and

FIG. 7 is a front perspective cross-sectional view of the air cleaner assembly of FIGS. 1 and 2 taken along the line 7-7 in FIG. 2.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention.

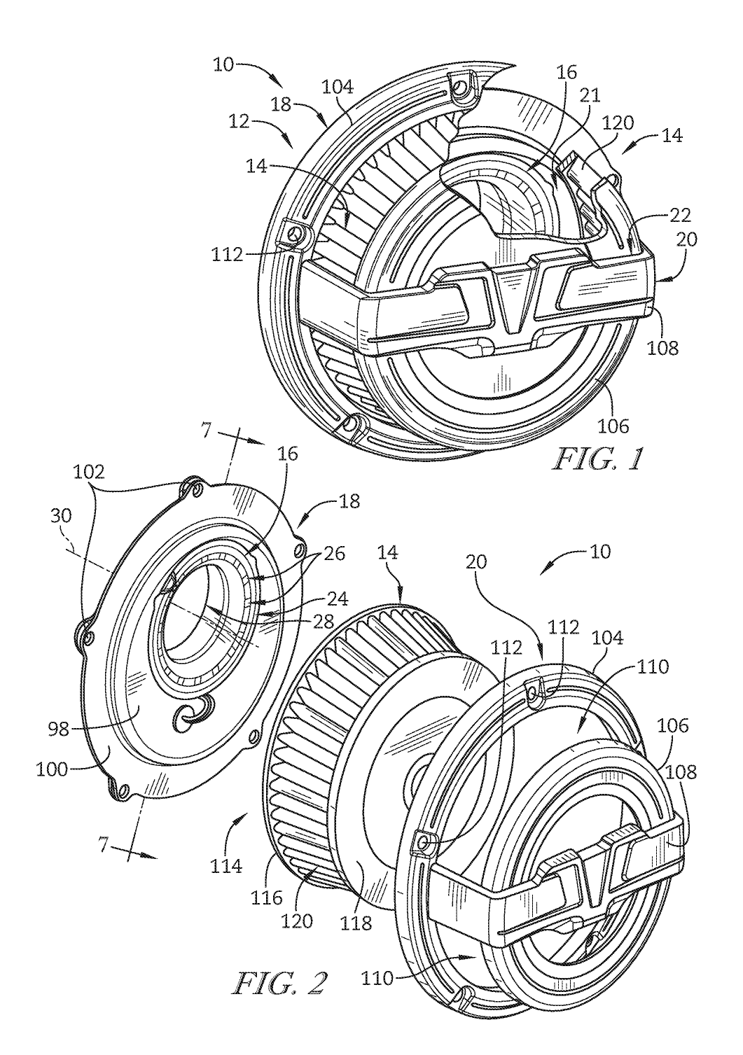

Referring now to FIG. 1, a lighted air cleaner assembly 10 of a motor vehicle is shown in an assembled state with a portion cut away to reveal the internal configuration. The assembly 10 includes a filter housing 12, an air filter 14 attached to the filter housing 12, and an air cleaner illumination device 16 for providing illumination. In the illustrative embodiment, light emitted from the illumination device 16 passes through the air filter 14 and is observable from the outside of the assembly 10 to provide a glowing appearance.

Referring to FIG. 2, the filter housing 12 illustratively includes a backplate 18 and a cover 20 that is configured to attach to the backplate 18. The backplate 18 illustratively includes a platform 98 and a rim 100 that surrounds and is offset from the platform 98. The rim 100 illustratively includes fastener holes 102 defined therethrough. The fastener holes 102 are illustratively located evenly around a periphery of the rim 100 for receiving fasteners therethrough to attach the backplate 18 to the cover 20.

The cover 20 illustratively includes a pair of braces 104, 106 and a bracket 108 connecting the braces 104, 106 together spaced apart from each other to define air openings 110. The brace 104 illustratively includes fastener holes 112 arranged complimentary to fastener holes 102 of the backplate 18 to receive fasteners therethrough for attaching the cover 20 to the backplate 18. The cover 20 is attached to the backplate 18 to together define the filter chamber 22 therein.

The filter chamber 22 is illustratively sized and shaped to receive the air filter 14 such that the air filter 14 is sealed against the backplate 18. The air filter 14 illustratively includes a filter support 114 including a base 116 and a top 118, and filter medium 120 arranged between the base 116 and top 118 to have corrugated folds for structural integrity. In the illustrative embodiment, the filter support 114 is illustratively comprised of plastic and the filter media is illustratively comprised of paper. In some embodiments, the filter support 114 may be formed of any suitable structure and/or materials, and/or the air filter medium 120 may be any suitable medium such as, for example, paper, foam, and/or cotton.

The air filter 14 illustratively has a tapered-cone shape, but in some embodiments may have any suitable shape for filtering air. The air filter 14 illustratively defines an interior cavity 21 that is enclosed by the backplate 18. In the illustrative embodiment, the base 116 of the air filter support 114 is sized complimentary to the platform 98 of the backplate 18 to receive the backplate 18 therein such that the base 116 abuts the rim 100 of the backplate 18. Air entering the interior cavity 21 from outside of the assembly 10 passes through the air filter media 120 to remove contaminants, for example, road debris and water.

As shown in FIG. 2, the illumination device 16 is illustratively disposed between the air filter 14 and the backplate 18 of the filter housing 12. In the illustrative embodiment, the illumination device 16 is positioned within the interior cavity 21 of the air filter 14 such that light emitted from the light sources 26 passes through the air filter 14 to provide a glowing appearance.

The illumination device 16 illustratively includes a housing 24 defining a passageway 28 and a number of light sources 26 that are attached to the housing 24 for emitting light. The passageway 28 extends through the housing 24 along an axis 30 and is sized and shaped to permit flow of air therethrough. In the illustrative embodiment, the light sources 26 are disposed evenly around the passageway 28.

In the illustrative embodiment, the light sources 26 are sealed within the housing 24 to resist contact with fluids. The housing 24 is illustratively formed of a transparent plastic material to allow light from the light sources 26 out of the housing 24. In some embodiments, the housing 24 may be formed of any suitable transparent material and/or the light sources 26 may be attached to the housing 24 and sealed by transparent material distinct from the housing 24 to resist contact with fluids.

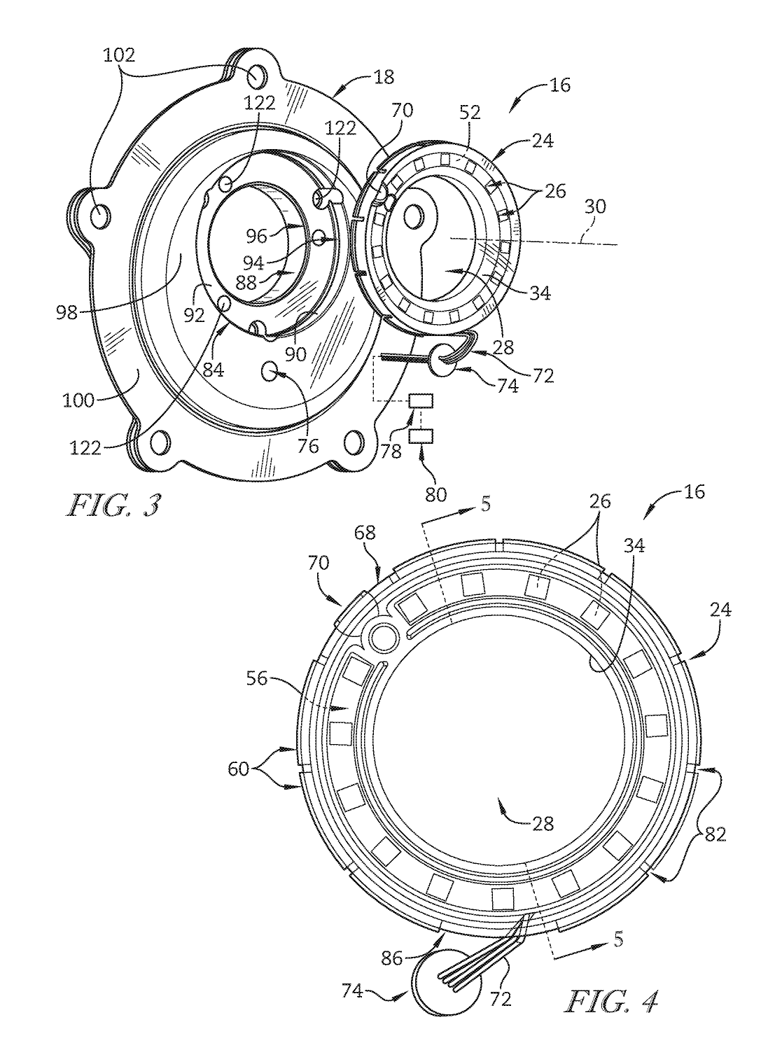

Referring now to FIG. 3, the illumination device 16 removably attaches to the air filter housing 12. The backplate 18 of the air filter housing 12 illustratively has a receptacle 84 defined therein that is sized and shaped complimentary to the housing 24 to receive the illumination device 16 for snap-fitting engagement. Receptacle 84 illustratively includes mounting holes 122 extending through the backplate 18 that are configured to receive fasteners for attaching the backplate 18 to the intake manifold of the vehicle. The receptacle 84 of the backplate 18 is illustratively defined by a perimeter wall 90 and a back wall 92 connected to the perimeter wall 90 and extending orthogonally therefrom.

An intake path 88 of the receptacle 84 extends through the back wall 92 for receiving air that has passed through the air filter 14. The receptacle 84 of the backplate 18 is illustratively configured to receive the illumination device 16 such that air that has passed through the air filter 14 flows through the passageway 28 and through the intake path 88 to an intake of the vehicle.

The receptacle 84 illustratively includes a snap groove 94 and an alignment grove 96. The snap groove 94 is illustratively defined in the perimeter wall 90 near the connection between the perimeter wall 90 and the back wall 92. The alignment groove 96 is illustratively defined in the back wall 92 near the intake path 88. As discussed in detail below, the snap groove 94 and the alignment groove 96 are each configured for engagement with housing 24 of the illumination device 16.

As shown in FIGS. 4 and 5, the housing 24 of the illumination device 16 includes a main wall 32 having an inner surface 34 and an outer surface 36 opposite to the inner surface 34. The passageway 28 is illustratively defined by the inner surface 34 of the main wall 32. In the illustrative embodiment, the main wall 32 is shaped as an annular wall extending between an end 40 of the housing 24 and an opposite end 44 of the housing 24. A notch 41 is defined in the outer surface 36 of the main wall 32 near the end 40 of the housing 24.

As shown in FIG. 5, the inner surface 34 of the main wall 32 is illustratively formed as an annular surface defining an opening 38 on the end 40 and another opening 42 on the opposite end 44. In the illustrative embodiment, the diameter of the opening 38 is illustratively larger than the diameter of opening 42. The passageway 28 extends between the opening 38 and the opening 42 along the axis 30 and is illustratively curved to have a decreasing diameter proceeding from opening 42 to opening 38 along the axis 30. The inner surface 34 is illustratively an annular surface having a horn-shape. The passageway 28 illustratively provides a smooth flow path to promote air flow therethrough.

The housing 24 of the illumination device 16 includes an enclosure walls 46 extending from the main wall 32 and a closure plate 52 attached to the enclosure wall 46 and the main wall 32. In the illustrative embodiment, each enclosure wall 46 is an annular wall that extends parallel to the axis 30 from the outer surface 36 of the main wall 32 to an end 50 thereof. Enclosure wall 46 is illustratively defines a notch 51 on its end 50 that is shaped to receive the closure plate 52.

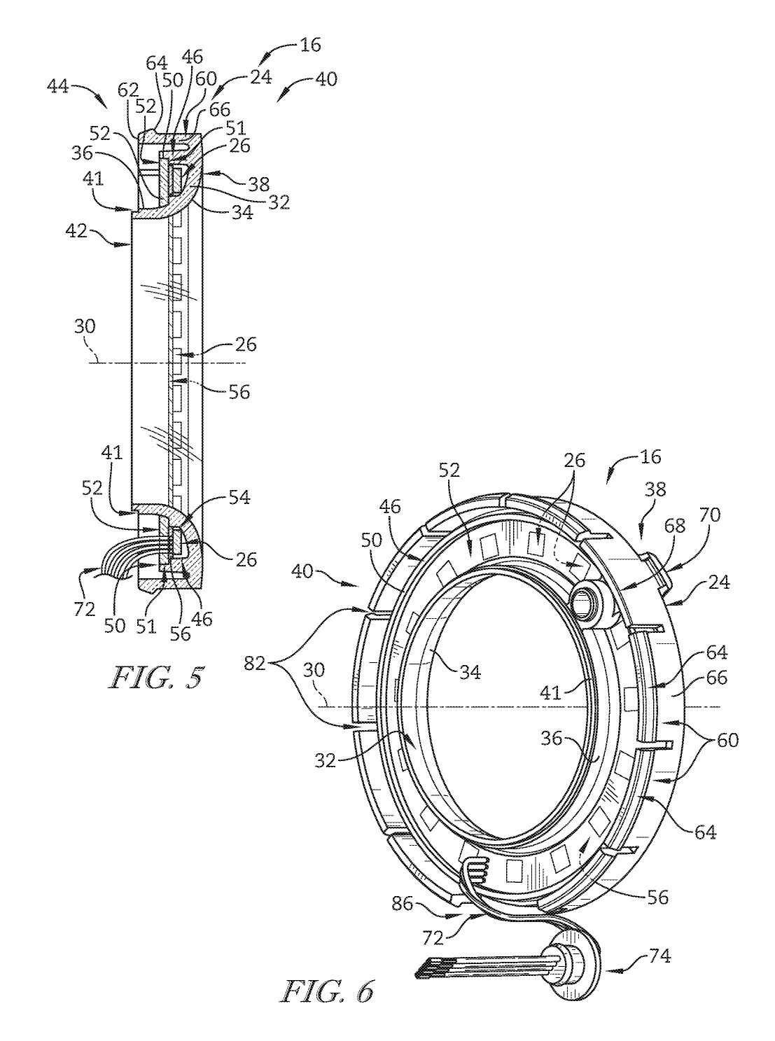

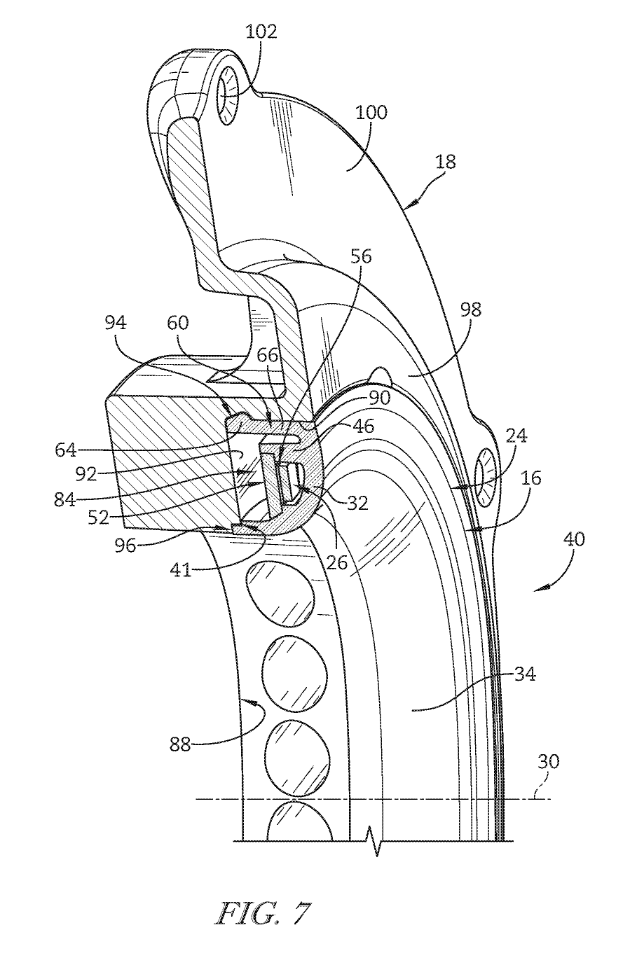

As shown in FIG. 6, the closure plate 52 is illustratively embodied as an annular plate configured to contact the end 50 of the enclosure wall 46 and the outer surface 36 of the main wall 32 to form a sealed cavity 54 therein. In the illustrative embodiment, the enclosure plate 52 is illustratively sized to be press-fit to the enclosure wall 46 and the main wall 32 to seal the light sources 26 within seal cavity 54 to prevent contact with fluids. In some embodiments, the enclosure plate 52 may be attached to the housing 24 in any suitable manner to form the sealed cavity 54 and/or an adhesive gasket may be applied to between the closure plate 52 and the housing 24 to fluidly seal the seal cavity 54.

In the illustrative embodiment, the light sources 26 are illustratively attached to the closure plate 52. The light sources 26 are illustratively embodied as light emitting diodes (LEDs) mounted onto and electrically connected to each other by a sheet 56. The sheet 56 is illustratively attached to a side of the closure plate 52. In the illustrative embodiment, the sheet 56 has an annular shape and the LEDs are evenly distributed around the circumference of the sheet 56. It should be appreciated that in some embodiments, the light sources 26 may be any suitable type of light source, and/or may be arranged in any shape and/or manner suitable to emit light from within the air cleaner assembly 10. In some embodiments, the sheet 56 may be circuit board and the closure plate 52 may be a potting material, for example, an epoxy applied directly to the sheet 56 positioned within the sealed cavity 54.

The housing 24 illustratively includes a number of mounting fingers 60, 68 configured for insertion into the intake path 88 of the backplate 18 for attachment thereto. Each mounting finger 60, 68 illustratively includes a flange 66 that extends from the main wall 32 parallel to axis 30 to an end 62 thereof that is cantilevered from the main wall 32.

The mounting fingers 60 are each illustratively distributed evenly around the passageway 28, with the exception of a member 68 and a gap 86 formed to allow a harness 72 to extend from inside the housing 24, as described in greater detail below. In the illustrative embodiment, the member 68 and the gap 86 are each illustratively equal in circumferential length to each flange 66. Each flange 66 is spaced apart from each other adjacent flange 66 to define a space 82 therebetween.

Each mounting finger 60 is illustratively configured for engagement with backplate 18 to secure the housing 24 thereto. Each mounting finger 60 illustratively includes a tab 64 extending outwardly from its respective flange 66 proximate to the end 62 thereof. Each tab 64 is illustratively shaped complimentary to the snap groove 94 of the receptacle 84 of the backplate 18 for snap-fitting engagement therewith.

A flange 70 illustratively extends radially outward from the inner surface 34 of the main wall 32 and is sized to receive a tool for assisting in removal of the housing 24 from the receptacle 84 of the backplate 18. The flange 70 illustratively extends from the main wall 32 outwardly beyond the member 68.

As shown in FIG. 7, the housing 24 is illustratively attached to the backplate 18 by snap-fitting engagement within the receptacle 84 of the backplate 18. When the housing 24 is snap-fitted into the receptacle 84, the mounting fingers 60, 68 illustratively extend into the receptacle 84 and abut the back wall 92 such that the tabs 64 of each mounting finger 60 are received within the snap groove 94. In the illustrative embodiment, the flanges 66 of each mounting finger 60, 68 are resiliently cantilevered into radial contact with the perimeter wall 90 such that the tabs 64 are removably received within the snap groove 94. The main wall 32 at the end 44 of the housing 24 is illustratively received within the alignment groove 96 and the notch 41 of the main wall 32 overlaps a portion of the backplate 18. It should be appreciated that in some embodiments, the housing 24 may be attached to the air filter housing 12 by any suitable means such as, for example, fastening to the backplate 18.

When the housing 24 is snap-fitted into the receptacle 84, the main wall 32 and the backplate 18 together form a generally smooth pathway for air flow. In the illustrative embodiment, the diameter of the intake path 88 is equal to the diameter of the inner surface 34 at the end 44 of the housing. The inner surface 34 of the main wall 32 at the end 44 of the housing 24 is illustratively aligned along the longitudinal direction and the radial direction with respect to the axis 30 with the intake path 88 to create a smooth transition therebetween.

In the illustrative embodiment, the diameter of the perimeter wall 90 is equal to the diameter of the inner surface 34 at the end 40 of the housing 24. The inner surface 34 of the main wall 32 at the end 40 of the housing 24 is illustratively aligned along the longitudinal direction and the radial direction with respect to the axis 30 with the intake path 88 to create a smooth transition therebetween.

Returning now to FIGS. 3 and 6, the illumination device 16 illustratively includes a wiring harness 72 for providing electric power to the light sources 26. The wiring harness 72 illustratively penetrates through the closure plate 52 and is electrically connected to the light sources 26. In the illustrative embodiment, the wiring harness 72 extends from the closure plate 52 and through the gap 86 to extend outside of the housing 24.

As shown in FIG. 3, the wiring harness 72 illustratively includes a mounting plug 74 positioned along the length of the wiring harness 72 and configured for insertion within an opening 76 of the backplate 18. The wiring harness 72 illustratively extends through the opening 76 for connection to a controller 78 and to a power source 80.

The controller 78 illustratively regulates operation of the light sources 26. In the illustrative embodiment, the controller 78 selectively operates light sources 26 for various operational modes including solid or flashing modes, and/or for solid color mode or cycling color change mode. A user can illustratively select the desired operational mode by input to the controller 78. In the illustrative embodiment, the controller 78 is attached to the vehicle and is positioned on an opposite side of backplate 18 relative to the illumination device 16. It should be appreciated that in some embodiments, the controller 78 may be positioned inside the sealed cavity 54 of the housing 24.

In the illustrative embodiment, the power source 80 is embodied as a power source of the vehicle, for example, an ignition of the vehicle such that power is supplied to the controller 78 when the ignition is turned on. In some embodiments, the power source 80 may be any suitable electrical power supply, for example, a battery, and/or may be wired directly to the light sources 26 without the use of the controller 78.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the apparatus, system, and method described herein. It will be noted that alternative embodiments of the apparatus, system, and method of the present disclosure may not include all of the features described yet still benefit from at least some of the advantages of such features. Those of ordinary skill in the art may readily devise their own implementations of the apparatus, system, and method that incorporate one or more of the features of the present invention and fall within the spirit and scope of the present disclosure.

What is claimed is:

1. An air cleaner illumination device for an intake of a motorized vehicle, the device comprising:
a housing,
a number of light sources attached to the housing and sealed to prevent contact with fluids, and
a wiring harness electrically connected to the number of light sources,
wherein a passageway is defined in the housing, the passageway being sized to permit flow of air into the intake of the motorized vehicle, and the number light sources are arranged around the passageway.

2. The air cleaner illumination device of claim 1, wherein the passageway extends through the housing along a first axis between a first opening defined in the housing and a second opening defined in the housing.

3. The air cleaner illumination device of claim 2, wherein the passageway is defined by a curved inner surface of the housing that extends between the first opening and the second opening when viewed in a cross-section taken along the first axis.

4. The air cleaner illumination device of claim 2, wherein the passageway is defined by a horn-shaped annular surface of the housing that extends between the first opening and the second opening.

5. The air cleaner illumination device of claim 1, wherein the housing includes a number of cantilevered fingers extending therefrom, each finger is configured to be received in an opening defined in the motorized vehicle.

6. The air cleaner illumination device of claim 5, wherein each of the number of fingers includes a flange extending from a rear wall of the housing to an end of the flange that is spaced apart from the rear wall.

7. The air cleaner illumination device of claim 6, wherein each of the number of fingers includes a tab extending from the end of the flange in a radially outward direction.

8. The air cleaner illumination device of claim 1, further comprising a controller configured to operate the number of light sources for a least one of flashing and changing color.

9. The air cleaner illumination device of claim 1, wherein the number of light sources include a plurality of light emitting diodes.

10. An air cleaner assembly for an intake of a motorized vehicle, the assembly comprising:
an intake mounting plate including an intake receptacle,
an air filter positioned on the intake mounting plate, and
an air cleaner illumination device including a housing and a number of light sources for emitting light disposed at least partly within the housing,
wherein the air cleaner illumination device is positioned such that the number of light sources emit light through the air filter.

11. The air cleaner assembly of claim 10, wherein the number of light sources are sealed by the housing to prevent contact with fluids.

12. The air cleaner assembly of claim 10, wherein the housing includes a passageway defined therein, the passageway being sized to permit flow of air into the intake of the motorized vehicle and extending through the housing along a first axis between a first opening defined by the housing and a second opening defined by the housing.

13. The air cleaner assembly of claim 12, wherein the number light sources includes a plurality of light sources arranged around the passageway.

14. The air cleaner assembly of claim 12, wherein the passageway is defined by a curved annular surface of the housing that extends between the first opening and the second opening when viewed in a cross-section taken along the first axis.

15. The air cleaner assembly of claim 12, wherein the passageway is defined by a horn-shaped annular surface of the housing that extends between the first opening and the second opening.

16. The air cleaner assembly of claim 10, wherein the housing includes a number of cantilevered fingers extending from the housing, each finger is configured for engagement with the intake receptacle of the mounting plate.

17. The air cleaner assembly of claim 16, wherein each of the number of fingers includes a flange extending from a wall of the housing to an end of the flange that is spaced apart from the wall.

18. The air cleaner assembly of claim 17, wherein each of the number of fingers includes a tab extending from the end of the flange in a radially outward direction for snap-fitting engagement with the intake receptacle of the mounting plate.

19. An air cleaner assembly for an intake of a motorized vehicle, comprising:
a filter housing including a backplate defining an intake receptacle and a cover configured to attach to the backplate, the filter housing defining a filter chamber,
a filter sized to be received within the filter chamber, the filter defining an interior cavity therein, and
an air cleaner illumination device including an illumination housing and a number of light sources for emitting light attached to the illumination housing,
wherein the air cleaner illumination device is selectively engaged within the intake receptacle and positioned within the interior cavity of the filter such that the number of light sources emit light from within the filter.
